(19) United States
(12) Patent Application Publication
(10) Pub. No.: US 2010/0068555 A1
(43) Pub. Date: Mar. 18, 2010

(54) CORROSION PROTECTIVE LAYER WITH IMPROVED CHARACTERISTICS

(75) Inventors: Alexander Tomandl, Amstetten (AT); Johann Gerdenitsch, Linz (AT)

Correspondence Address: PAULEY PETERSEN & ERICKSON, 2800 WEST HIGGINS ROAD, SUITE 365, HOFFMAN ESTATES, IL, 60169, US

(73) Assignee: VOESTALPINE STAHL GMBH, Linz (AT)

(21) Appl. No.: 12/309,652

(22) PCT Filed: Jul. 17, 2007
(86) PCT No.: PCT/EP2007/006336

§ 371 Date: Nov. 16, 2009

(30) Foreign Application Priority Data
Jul. 31, 2006 (DE) 10 2006 035 660.8

(51) Int. Cl. B32B 15/08; C25D 5/00

(52) U.S. Cl. 428/626; 205/196

(57) ABSTRACT

The invention relates to a corrosion-protective layer for protecting steel substrates from corrosion, comprising a zinc-chromium layer applied on the steel substrate by electrolytic joint deposition of zinc and chromium ions, and a chromate-free organic thin layer applied thereon, substantially comprising synthetic resins, and to a method for improving the paint adhesion of a zinc-chromium corrosion-protective layer.

### FIELD OF THE INVENTION

The invention relates to a corrosion-protective layer with improved properties.

### BACKGROUND OF THE INVENTION

A method for producing steel sheets electroplated with a zinc-chromium alloy having excellent adhesive strength is known from EP 0 566 121 B1. In this method, the surface of the steel sheet is electroplated using an acid electroplating bath containing zinc ions and chromium ions in a certain molecular concentration ratio, with at least one non-ionic organic additive having at least one triple bond being contained therein.

Polyethylene glycol (PEG) is known as an additive in the electrodeposition of zinc-chromium alloys from “Journal of Applied Electrochemistry”, 30, pages 870 to 822 “Role of polyethylene glycol in electrodeposition of zinc-chromium alloys”.

From “Corrosion resistance of ZN—CR Alloy electrocoated Steel Sheets” by Kanamura, T., Suzuki, S. and Arai, K., the improvement of corrosion protection, in particular for automotive steel sheets, using various kinds of zinc-based coatings is known, the article stating that, though an increase of the layer thickness increases corrosion resistance, it reduces formability and weldability at the same time. One solution of the problem should lie in providing an only lightly-coated steel strip having good corrosion resistance. Zinc-chromium alloys having a chromium content of 5-20% in the coating were investigated for this purpose, the conclusion being that zinc-chromium is a material that has an excellent corrosion resistance even in the case of a thin coating, with a coating of 20 g/m² already being considered very good. In addition, zinc-chromium coatings are supposed to offer sufficient cathodic protection and be effective in the prevention of edge corrosion. The insufficient phosphatability of ZnCr layers is also described.

An organic-coated steel composite sheet consisting of a surface which is coated on one or two sides with zinc or a zinc alloy, with the surface being provided with a chromate film, and an organic coating located thereon having a layer thickness of 0.1 to 5 μm is known from EP-A-573015. The organic coating is formed of a primary composition consisting of an organic solvent, an epoxy resin having a molecular weight of between 500 and 10,000, an aromatic polyamide and a phenol or cresol compound as a promoter. The organic coating is applied with a dry-film layer thickness of 0.6 to 1.6 μm because layers thinner than 0.1 μm are too thin to effect a corrosion protection. Thus, the organic layer has a substantial part in the corrosion protection in this entire coating. At layer thicknesses of more than 5 μm, weldability is said to be affected.

DE-A-3640662 relates to a surface-treated steel sheet comprising a steel sheet covered with zinc or a zinc alloy, a chromate film formed on the surface of the steel sheet and a layer of a resin composition formed on the chromate film. This resin composition should consist of a basic resin produced by reacting an epoxy resin with amines, as well as of a polyisocyanate compound. This known film may also only be applied at dry-film thicknesses of less than approximately 3.5 μm because the suitability for welding is much reduced at greater layer thicknesses.

A sliding and weldable corrosion-protective primer for a thinly electrogalvanized, phosphated or chromated and deformed steel sheet is known, wherein this corrosion-protective primer consists of a mixture of more than 60% zinc, aluminum, graphite and/or molybdenum sulfite as well as another corrosion-protective pigment and 33 to 35% of an organic binder and approximately 2% of a dispersing agent or catalyst, is known from DE-C-3412234. Polyester resins and/or epoxy resins and their derivatives are proposed as binders. Such a corrosion-protective primer is sold on the market under the name “Bonazinc 2000” by the company BASF. However, such a coating cannot be spot-welded sufficiently well, and the stoving temperature is too high, so that many modern steels cannot be used for this anymore. Additionally, paint adhesion is not sufficient in every case.

A conductive and weldable corrosion-protective composition for coating metal surfaces as well as a method for coating metal surfaces with electrically conductive organic coatings is known from EP 1 030 894 B1. This document is based upon the object of providing a coating composition that satisfies the requirements of the automobile industry, with the composition being suitable for the coil coating method, with a low stoving temperature and a more distinct reduction of the white rust on galvanized steel sheet being achievable, the adhesion of the organic coating on the metallic substrate being improved, and with sufficient corrosion protection even with a thin chromium coating in the case of chromating and preferably in the case of chromium-free pre-treatment methods. In addition, there is supposed to be a suitability for spot-welding, and the use of other corrosion protection products, such as cavity sealing, is supposed to be superfluous. To this end, the coating is supposed to comprise 10 to 40% by wt. of an organic binder, 0 to 15% by wt. of a silicate-based corrosion-protective pigment, 40 to 70% by wt. powdery zinc, aluminum, graphite and/or molybdenum sulfite, as well as 0 to 30% by wt. of a solvent, the organic binder is at least an epoxy resin, and is supposed to contain at least one curing agent selected from the group consisting of guanidine, substituted guanidines, substituted ureas, cyclic tertiary amines and mixtures thereof, and at least one blocked polyurethane resin.

A corrosion-protective primer is known from DE 102 56 286 A1, which is supposed to be suitable for the low-wear deformation of, for example, steel sheets as they are processed in the automobile industry in mass production. Despite the one-sided or even two-sided coating with zinc or a zinc-containing alloy, with a thin pre-treatment layer constituting corrosion protection as well as a wash primer for the following primer, and with a welding primer coating of a thickness of between 0.5 to 10 μm thickness, this coating is supposed to be sufficiently electrically conductive in order to be readily weldable. The zinc and zinc-containing alloys mentioned herein probably are the alloys commonly used in automobile production: electrolytic zinc layer, hot-dip galvanized layer (0.2% aluminum content), Galfan (5% aluminum content), Galvanealed and Galvalume (zinc content and aluminum content approx. 50% each). The object is supposed to be achieved with a lacquer-like mixture comprising resin and inorganic particles for applying a polymeric, corrosion-resistant, electrically conductive and electrically weldable coating which can be shaped in a low-wear manner.

A zinc-chromium coating for automotive sheets is known from EP 0 607 452 A1, and it is stated that zinc-chromium layers are advantageous as compared with conventional zinc-based alloy layers on steels in that the resistance against corrosion is greater than that of the other layers in the original state. It is stated, however, that although zinc-chromium alloyed layers have an improved corrosion resistance, this applies only to the pure sheet material and that the resistance against corrosion on the outer surface of an automobile body is weak (due to deformation processes). This is related to the poor deformability of the zinc-chromium layers. It is additionally said that every coating has a corrosion resistance that improves with an increasing coating weight, the exact opposite being the case where zinc-chromium coatings are concerned because deformability drops under the influence of an increase in layer thickness. It is also said that zinc-chromium layers are particularly susceptible to chipping. Furthermore, it is explained that the corrosion resistance of a zinc-chromium layer increases with the chromium content, which, however, is disadvantageous in that the coating adhesion on the bare metal decreases with an increase in chromium content. The aforementioned problems are to be solved by a special phase composition being selected in zinc-chromium layers, where a structure is achieved that is hexagonal, and where the lattice constants have a certain size.

However, it was found that such zinc-chromium layers have the usual disadvantages which make their use in the automobile industry appear impossible even given a compliance with such lattice constants.

A composition for treating metals and a method for applying the treatment is known from EP 0 777 763. An intermediate coating for achieving a better paintability is proposed in this document, with the otherwise commonly used chromating for automotive sheets being avoided.

A chromating treatment such as this is known, from EP 0 630 993 A1, as a pre-treatment before painting, with such chromating treatments still being common today while alternative methods, such as that of EP 0 777 763, have not gained acceptance.

A coated steel sheet on which a zinc-chromium coating is deposited is known from EP 0 285 931 A1. It states that, before painting, the primary zinc-chromium coating is preferably covered with an additional zinc or zinc-iron-layer, preferably with a coating containing more than 60% by wt. iron in order to improve the bonding properties to a conventional phosphate coating. Therefore, it also states in this regard that zinc-chromium coatings practically cannot be phosphated.

A steel plate having an organically composed plating is known from the Japanese published patent application HEI 9-276789, in which a steel substrate is embodied with a zinc-nickel alloy, a zinc-iron alloy or a zinc-chromium alloy, with this alloy being subjected to a chromate treatment and an organic coating being present, the organic coating, however, is supposed to contain strontium chromate, calcium chromate, zinc chromate, barium chromate or ammonium chromate as well as ammonium bichromate.

Also from the Japanese published patent application HEI 9-277438, a weldable steel plate is known having an organically composed plating, wherein a chemical treatment is carried out on both sides of the coated steel plate with a phosphoric acid compound as a main component in order to improve the corrosion of the coating as well as the adhesion between the steel plate and a paint layer. In particular, the phosphoric-acid treatment is supposed to be carried out on the plated steel plate, i.e. the steel plate coated with zinc-iron, zinc-nickel or zinc-chromium, the crystals of the phosphoric acid compound being deposited on the surface.

From JP 07292480, it is known to coat a coated steel plate with an aqueous polymer in order to make possible a subsequent phosphating treatment.

In principle, galvanized steel sheets that have been provided with a corrosion-protective primer prior to painting them and which are then phosphated and/or chromated were proven to be of value. The disadvantages in these layers, however, is that weldability suffers due to the additional organic layer in the form of the corrosion-protective primer. In the case of zinc layers, the corrosion-protective primer is necessary in order to ensure sufficient corrosion protection in the area of the flanges.

Furthermore, the use of zinc-chromium coatings on steel sheets was attempted, with a relatively high corrosion resistance in the uncoated state constituting a positive property, and the effect of the cathodic protection was similar to that of zinc. Corrosion resistance is so high that additional corrosion-protective primer can be dispensed with even in the unpainted flange area.

In addition, a chromate treatment of the layer or at least another pretreatment is a necessary requirement in zinc chromium layers. However, a chromate treatment entails many problems due to the presence of highly toxic chromium (VI) ions. Other pre-treatments constitute a complex intermediate step, as is known from EP 0 285 931 A1 or EP 0 777 763.

However, zinc chromium layers were not able to establish themselves for coating sheets, in particular for the automobile industry, since they do not possess phosphatability. This is due to the fact that inhomogeneous phosphate layers form on zinc chromium layers during the phosphate treatment. Areas having a high deposition of phosphate and areas that were not phosphated can both be found on the surface.

However, this irregular deposit degrades adhesion compared to pure zinc, or even in comparison to zinc-chromium layers that were not subjected to a phosphating treatment. Omission of the phosphating treatment improves paint adhesion on the zinc chromium layer. However, in order to be employed in the automobile industry, it must be ensured that the surface may run though a phosphating bath without any negative effects, because this process is inevitably always carried out on the entire car body.

Additionally, the high degree of abrasion during the deformation of the sheets, which increases with the chromium content and the thickness of the zinc-chromium coating, is a considerable drawback. The degree of abrasion during deformation is so high that abrasion reaches the base material in particularly strongly deformed areas, so that the positive corrosion protection properties are non-existent.

The fact that zinc chromium layers do not require a corrosion-protective primer would, however, be considered positive because sufficient corrosion protection is always ensured in contrast to zinc, even in the area of flanges and raised edges.

As was already explained, a corrosion-protective primer is applied onto zinc layers, the corrosion-protective primer (cpp) serving the purpose of improving corrosion protection in areas which the paint does not penetrate during the subsequent painting, in particular the flange areas, raised edges, etc. A corrosion-protective primer on a zinc layer therefore only improves flange corrosion. However, an improvement of the paint sub-surface migration and edge corrosion is not observed.

It is the object of the invention to provide a corrosion-protective layer with improved properties, which, when traveling through a conventional painting line with a conventional painting process in which paint build-up follows the phosphating treatment, results in a good paint adhesion, which additionally improves edge corrosion as compared with zinc layers or zinc chromium layers, and which counteracts a sub-surface migration of the paint. Furthermore, an intended accomplishment is a layer which is improved with regard to environmental aspects.

It is another object to provide a method for producing a corrosion-protective layer having an improved paint adhesion.

### SUMMARY OF THE INVENTION

According to the invention, a zinc-chromium layer is electrolytically applied onto a steel sheet, and a thin chromate-free organic layer is then applied. A pre-treatment, and in particular a chromating treatment of the layer, i.e. the use of chromium (VI) ions, is not carried out.

The result achieved is a corrosion-protective layer having excellent paint adhesion and very good mechanical properties, in particular with regard to deformation.

In the process, the zinc-chromium layer is, in particular, formed to be thinner than would actually be required for corrosion protection. In conjunction with the corrosion-protective primer, the zinc-chromium layer can be formed to be so thin that no abrasion problems arise, but with sufficient corrosion protection being ensured nevertheless.

Similarly, the organic layer, which consists, in particular, of a conventional corrosion-protective primer, is formed to be thinner than would actually be required in order to achieve the usual corrosion-inhibiting effect of the corrosion-protective primer on a zinc layer. According to the invention, the organic layer is chromium-free.

Overcoming the prejudice of applying the corrosion-protective primer on the one hand, which is actually superfluous on zinc-chromium layers, and the use of layers on the other hand which are actually thinner than appears necessary in order to be effective, yields surprising synergistic effects.

Resistance against stone chipping and, in particular, paint adhesion in a conventional zinc layer is known, for example, with resistance against stone chipping and paint adhesion in a zinc-chromium layer being inferior to a zinc layer.

Deformability and abrasion, which in a normal zinc layer correspond to a given quantity, usually are poorer in a corresponding zinc-chromium layer.

In the prior art, the application of a corrosion-protective primer onto a zinc layer does not improve its resistance against stone chipping and its paint adhesion properties; instead, they remain substantially the same. Deformability of such a layer improves over the pure zinc layer due to modified tribological properties.

What is surprising, however, is that the resistance against stone chipping and the paint adhesion is considerably better given a layer configuration according to the invention, which consists of a thin zinc-chromium layer and an organic layer based on synthetic resin and, in particular a corrosion-protective primer, than the resistance against stone chipping and paint adhesion of a pure zinc layer or a zinc layer plus corrosion-protective primer.

Whereas the deformability of a pure zinc-chromium layer is poor, deformability of the organically coated zinc-chromium layer according to the invention is at least as good as that of a zinc layer+corrosion-protective primer.

A synergistic effect, however, not only results with respect to the tribological characteristic values discussed above, but also with regard to the chemical characteristic values, in particular with regard to corrosion in the flange area, on edges and scratches.

Compared with a conventional zinc layer, a zinc-chromium layer, as was already explained in the introduction, yields improvements with respect to corrosion resistance of the three types of corrosion mentioned (flange, edge, scratch), which is why no organic coatings are applied onto zinc-chromium layers in the prior art. If a zinc layer is provided with a corrosion-protective primer, the result may be a slightly improved flange corrosion, but the corrosion resistance at the edge and in the area of a scratch remains the same as compared with a zinc layer. The reason for this is that the advantages of the corrosion-protective primer can only be perceived in those areas that are not penetrated by paint during the subsequent painting. This is the flange area.

Surprisingly, it was found that where a zinc-chromium layer, which, in particular, is formed to be thin, and a corrosion-protective primer are combined, corrosion resistance is increased considerably as compared with a pure zinc-chromium layer, and that it increases in such a considerable degree, compared with a pure zinc layer or a zinc layer with a corrosion-protective primer, that this cannot be ascribed to the mere combination of the good properties of the zinc-chromium layer on the one hand and the corrosion-protective primer on the other hand.

The zinc-chromium layer can have a thickness of 1 to 10 μm, preferably of 2.0 to 6 μm, with the chromium content being 1 to 25%, preferably 3 to 10%. The organic thin film, which is applied onto the zinc-chromium layer, for example in a way [[a]] similar to that of a corrosion-protective primer or using a corrosion-protective primer which is conventional as such, has thicknesses of 0.5 to 10 μm, in particular 1 to 8 μm, for example 2 to 6 μm. However, the synergistic effects that occur in the invention are achieved even at a layer thickness of just 0.5 μm.

Thus, layer thicknesses of 4 to 6 μm are possible. Such a corrosion-protective layer alone, which has a thickness of 4 to 6 μm, achieves an improvement of the corrosion resistance and the tribological properties over a zinc layer having a thickness of 7 or 7.5 μm. Even a zinc layer of 7.5 μm, which has a conventional corrosion-protective primer coating of an additional 2 to 6 μm, cannot compare to the excellent properties of the corrosion-protective layer according to the invention.

During the coating of conventional zinc layers with a corrosion-protective primer, a pre-treatment is carried out with special chemicals, usually chromates, and the corrosion-protective primer is subsequently applied. The corrosion protection and the paint adhesion are deficient without this chemical pre-treatment. Surprisingly, such a chemical pre-treatment, in particular a chromating treatment, or a chromium-free pre-treatment, in particular a phosphating treatment, can be omitted in the case of zinc-chromium layers.

The invention will be explained in reference to a drawing with a number of figures as well as with various examples.

### BRIEF DESCRIPTION OF THE DRAWINGS

FIG. 1 shows a bar chart showing the resistance against stone chipping of various layer systems.

FIG. 2 shows a table showing the composition of 17 comparative examples.

FIG. 3 shows a rough configuration of samples for carrying out the examinations.

FIG. 4 shows a process flow for an alternating climate test.

FIG. 5 shows a table showing eight comparative samples in the abrasion test.

FIG. 6 shows a bar chart showing the abrasion in accordance with the table of FIG. 5.

FIG. 7 shows a table showing the chipped-off area in stone chipping tests in eight different comparative examples.

FIG. 8 shows a bar chart for comparing the results of the table of FIG. 7.

FIG. 9 shows a table showing the results of a test which shows the corrosive sub-surface migration on a scratch.

FIG. 10 shows a bar chart showing the results of the table of FIG. 9.

FIG. 11 shows a table showing the results in a flange-corrosion test.

FIG. 12 shows a bar chart showing the results of FIG. 10.

FIG. 13 shows a table showing the sub-surface migration on the edge in further test examples.

FIG. 14 shows a bar chart showing the results of the table of FIG. 13.

FIG. 15 shows a summary of the results in a table form.

FIG. 16 shows a summary of the results in a table form.

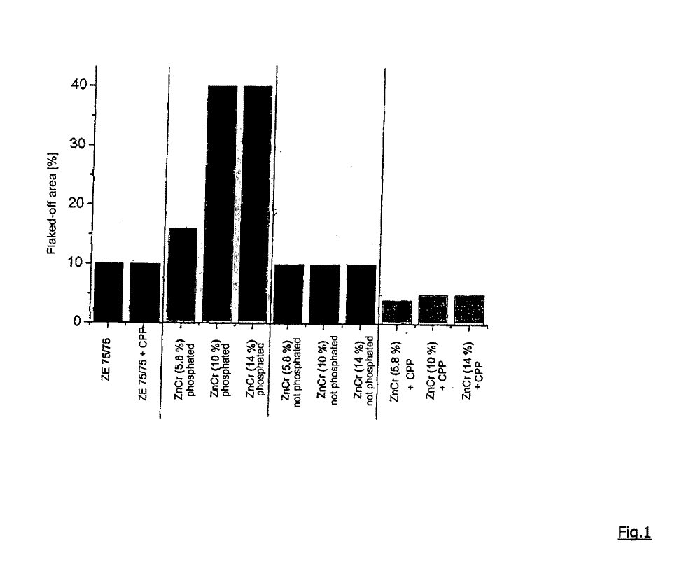

### DETAILED DESCRIPTION OF THE PREFERRED EMBODIMENTS

The comparative samples were produced as follows:

I. Deposition of the Zn—Cr Layer

The samples are coated on a laboratory coating cell with an adjustable flow rate. Sheets of mild steel (thickness 0.8 mm) and a size of 150×100 mm are coated. The following chemicals are used for producing the electrolyte:

| | |
|---|---|
| zinc sulfate heptahydrate: | ZnSO₄×7H₂O |
| chromium potassium sulphate dodecahydrate: | KCr(SO₄)₂×12H₂O |
| sulfuric acid: | H₂SO₄(98%). |

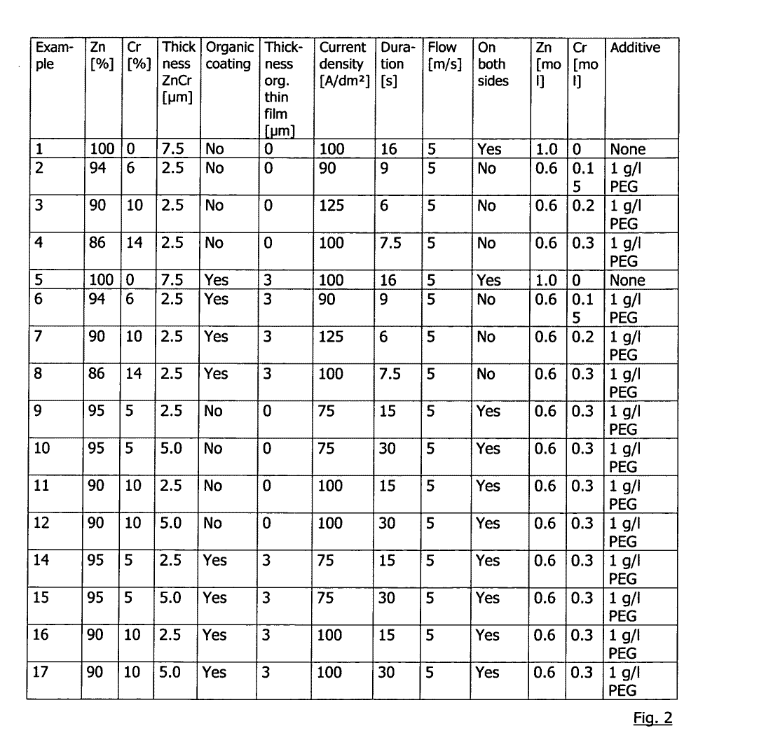

The exact concentrations for depositing the exemplary samples are specified in FIG. 2. The pH value of the electrolyte is 2, deposition takes place at a temperature of 40° C.

The organic thin film is applied using a doctor blade, then, the layer is cured for 30 seconds at an object temperature of 250° C. in an oven.

Polyethylene glycol 6000 (PEG) was added as an additive during the deposition. The organic thin film (corrosion-protective primer, cpp) consisted of a commercially available product “Granocoat ZE” by Henkel KGaA, with the surface being pre-treated with the commercially available product “Granodine 1456”, also by Henkel KGaA. The latter pre-treatment is not a pre-treatment within the sense of a chromating or phosphating treatment because no crystals are deposited, it is an amorphous conversion layer.

According to the invention, this pre-treatment may also be omitted.

II. General Description of Organic Thin-film Coatings

On a large scale, the organic thin-film coatings are applied inline on galvanized steel in a strip coating plant. They are characterized by weldability, deformability and a corrosion-protective effect.

Such thin-film coatings preferably contain at least 5% by wt. of electrically conductive particles, (e.g. Zn, Fe, FeP or similar materials). The coatings are paint-like and can be formulated on a resin-basis (polyurethane, epoxy or the like). Other common constituents are polyester, guanine derivatives, ureas, melamine resins, amines (cyclic and aromatic) and alcohols (ethylene glycol, propylene glycol, butanediol and hexanediol). According to the invention, only chromate-free thin-film coatings are being used.

Prior to the application of the organic thin film, the metal sheets are treated with a solution which produces a conversion layer on the surface for better adhesion of the thin film. Usually, these systems are based on hexafluorotitanates, zirconates, phosphates and manganese salts. This corrosion layer is applied using the so-called no-rinse process. Here, the treating solution is applied onto the surface, squeezed off and dried. In contrast to a phosphating process, no phosphate crystals form, but rather thin amorphous layers of phosphates.

III. Treatment of the Testing Samples

### (Pretreatment Prior to CPP)

Treatment was carried out by dipping into the appropriate solution, subsequent squeezing off of the samples and drying at 70° C. for 5 seconds in order to form the amorphous corrosion layer, before the organic thin film was applied as described above.

IV. Painting

The samples are treated in a manner typical for automobile manufacture for the examinations regarding the resistance to stone chipping, sub-surface migration at scratches/edges and edge corrosion:

a) Cleaning:

First, a cleaning process using a mildly alkaline cleaning agent (pH 11) is carried out. The cleaning process is carried out using a commercially available product, “Ridoline 1556” by Henkel KGaA, for 5 minutes at 55° C. Then, the samples are rinsed.

b) Activation

The samples are activated in a colloidal solution (5 g/l) of sodium titanyl phosphate under the brand name “Fixodine 50CF) by Henkel KGaA for the purpose of generating the conversion layer or activation.

c) Phosphating:

Then, the samples are phosphated in a nitrate-accelerated trication phosphating treatment, the treatment being carried out for 4 minutes at 50° C. (product name: granodine 958).

d) Painting:

Finally, the samples are painted with an electro dip paint “Enviroprime” by PPG up to a thickness of 25 μm.

V. Carrying out the Test

V.1 Abrasion

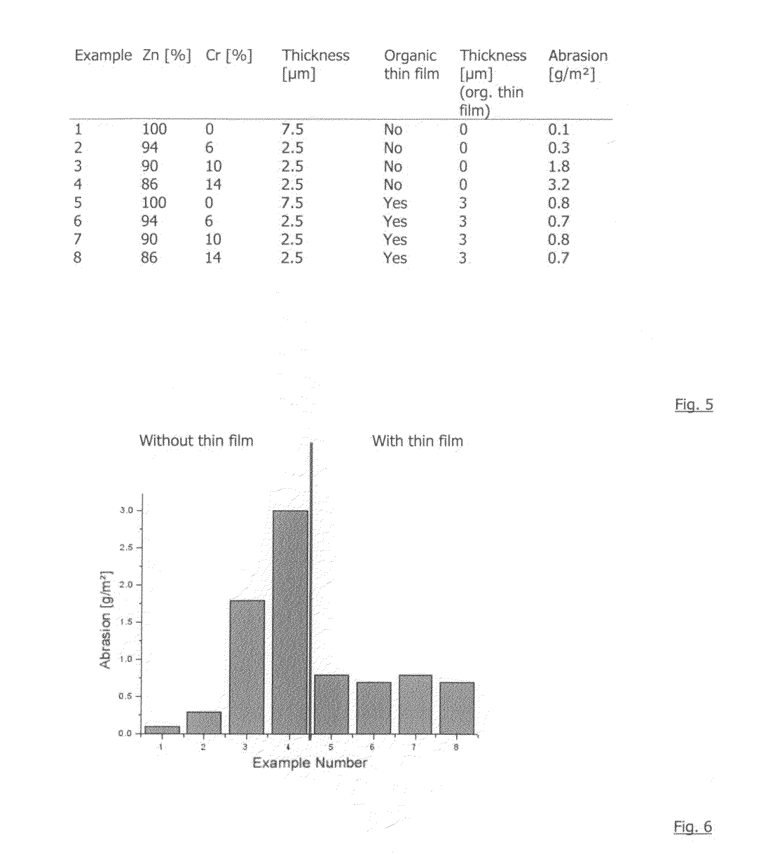

A cup is drawn from circular unpainted samples having a diameter of 66 mm. The drawing ratio is 2, i.e., the result is cups having a diameter of 33 mm, with the drawing speed being 100 mm/sec. The difference in weight before and after the deep-drawing process is put in relation to the layer thickness on the circumferential surface of the cup and given as an abrasion percentage. This test simulates abrasion during deformation and is shown in FIGS. 5 and 6.

V.2 Corrosion Tests

V.2.1 Flange Construction

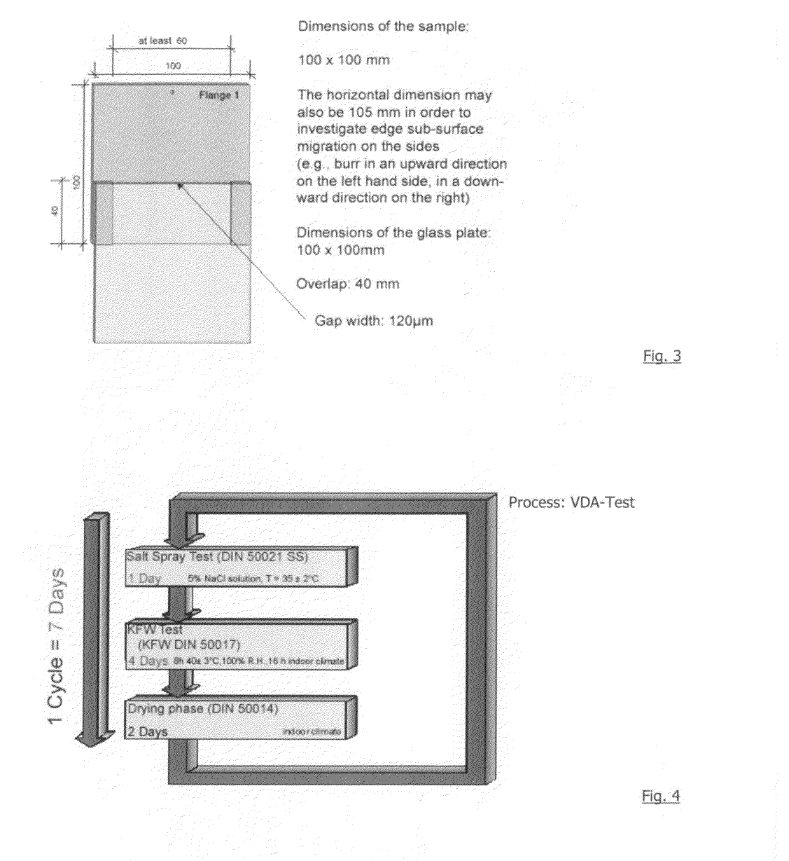

In order to simulate the corrosion in a flange area, samples of a size of 10×10 cm are half covered with a glass plate of equal size. The distance between the sample and the glass plate is 120 μm. The size of the sample can be seen in FIG. 3; the horizontal size can also be 105 mm for examining the sub-surface migration of the edges at the sides (for example, burr directed upwardly up on the left of FIG. 3, or downwardly on the right).

V.2.2 Alternating Climate Test

For 10 weeks, the samples are subjected to an alternating climate test in accordance with VDA 621-415 so that, in particular, 10 cycles are passed (7 days per cycle), with this alternating climate test being a combination of a salt spray test in accordance with DIN 50021 SS, a KFW test (Condensation climate with alternating humidity and air temperature) in accordance with DIN 50017 and a drying phase in accordance with DIN 50014. The process is shown in FIG. 4.

V.2.3 Stone Chipping

The painted samples produced in accordance with IV are bombarded with stone shot in accordance with DIN 55996-1 before and after having been transferred to the corrosion test. The flaked-off paint area is determined by image analysis.

V.2.4 Sub-surface Migration in Scratches

Prior to the transfer to the corrosion test, the painted samples are scratched through to the base steel material. The paint which has undergone sub-surface migration is removed after the corrosion test and the width of the sub-migrated scratch is measured.

V.2.5 Edge Sub-Surface Migration

The paint which has undergone sub-surface migration is removed from the direction of the sample edge after the corrosion test, and the width of the sub-migrated area from the edge to the intact paint is determined.

V.2.6 Flange Corrosion

The assembled glass flanges come into the corrosion test and are inspected weekly. The duration (in weeks) until the appearance of the first steel corrosion products (red rust) under the glass plate is determined.

VI. Results

Eight different samples were compared in the abrasion test (FIGS. 5, 6). Samples 1 and 5 are steel samples with a 7.5 μm electrolytic galvanization which contain no chromium at all, where sample 1 does not contain any organic coating and sample 5 contains a 3 μm organic coating. It can be seen that the abrasion of the organically coated sample is 8 times higher than that of the pure galvanized steel sample. In contrast, the samples 2 and 6 were manufactured to have a zinc-to-chromium ratio of 94:6, the samples 3 and 7 with a zinc-to-chromium ratio 90:10, and the samples 4 and 8 with a zinc-to-chromium ratio of 86:14. Here, the thickness of the zinc-chromium layers in each case was 2.5 μm, with no organic coating being applied onto samples 2, 3 and 4, and a 3 μm organic coating on the samples 6, 7 and 8. The term organic coatings here denotes, in particular, corrosion-protective primers. Whereas abrasion increases, as was expected, with growing chromium content in the samples 2, 3 and 4, abrasion practically remains the same at a growing chromium content and with an organic coating of 3 μm.

Therefore, while abrasion (dramatically) increases when an organic coating is applied onto a conventional zinc layer (sample 5), the abrasion behavior in a zinc-chromium layer changes, obviously irrespective of the chromium content, in a totally surprising manner in exactly the opposite way, i.e. abrasion losses decrease dramatically. Such a behavior was in no way to be expected, because abrasion in zinc-chromium coating that do not have an organic coating, as is known up to date, increases sharply with a growing chromium content, and abrasion increases also, as is also known, in pure electrolytic zinc layers treated with a corrosion-protective primer. Abrasion is now being determined by the abrasion of the organic layer, and is independent from the abrasion of the zinc-chromium layer.

Thus, the invention leads to a result with respect to the abrasion which is contrary to the expectations of the person skilled in the art.

VI.2 Stone Chipping

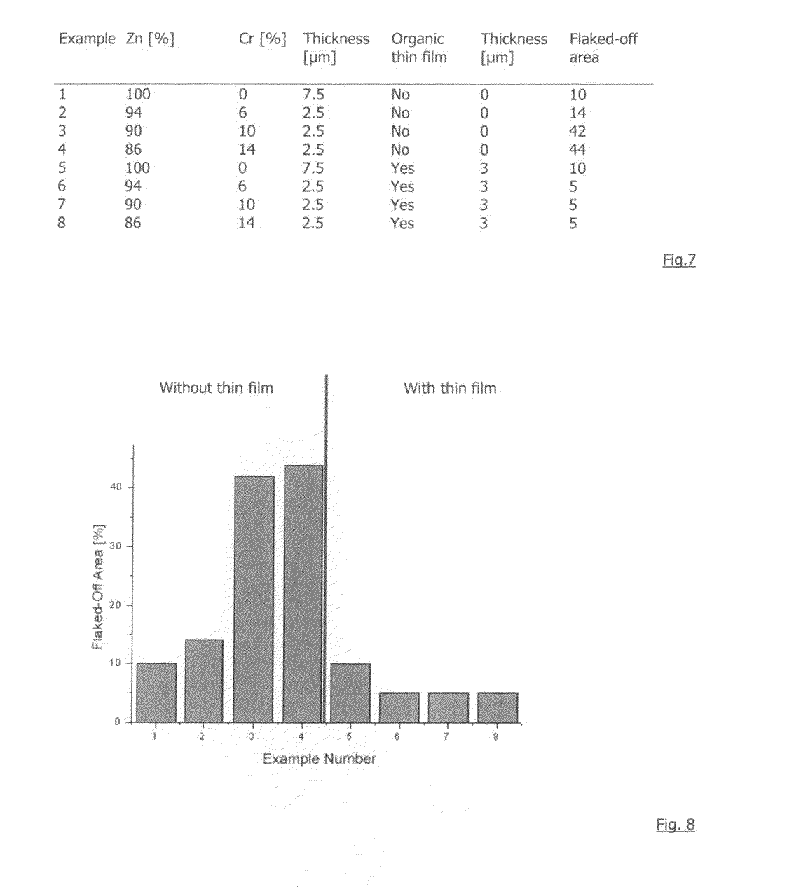

Again, eight samples were used which matched the eight samples from V.1 as regards their structure (see FIG. 7). In the stone chipping test, the samples 1 and 5, which have a pure galvanization, show the same flake-off behavior irrespective of whether there is an organic coating (cpp) (sample 5) or not (sample 1). Samples 2, 3 and 4, which are zinc-chromium layers with an increasing chromium content, exhibit a known stone-chipping behavior of zinc-chromium layers, because brittleness normally increases with a growing chromium content. As was expected, it was found that the flaked-off area increases as the chromium content increases. Given a zinc-chromium ratio of 86:14, the flaked-off area is four times as large as is the case for a pure electrolytic zinc layer.

Whereas a cpp coating does not make any difference in a pure electrolytic zinc layer with regard to the stone chipping behavior, the cpp coating in zinc-chromium layers, completely surprisingly, causes a reduction of the flaked-off area irrespective of the chromium content, with the flaked-off area being only half the size as that in a pure electrolytic zinc layer of 7.5 μm. The surprising effect which the organic layer has on a zinc-chromium coating becomes particularly clear given a zinc-chromium ratio of 86:14 and the organic coating.

Compared with a non-organically coated zinc-chromium layer with the same composition, the flaked-off area is just about one-eighth of the size.

This strong effect also cannot be expected based on the behavior of electrolytic zinc layers with corrosion-protective primers, which are usually used on them. Zinc-chromium layers without corrosion-protective primers that are subjected to a phosphating treatment exhibit poorer paint adhesion in the stone chipping test.

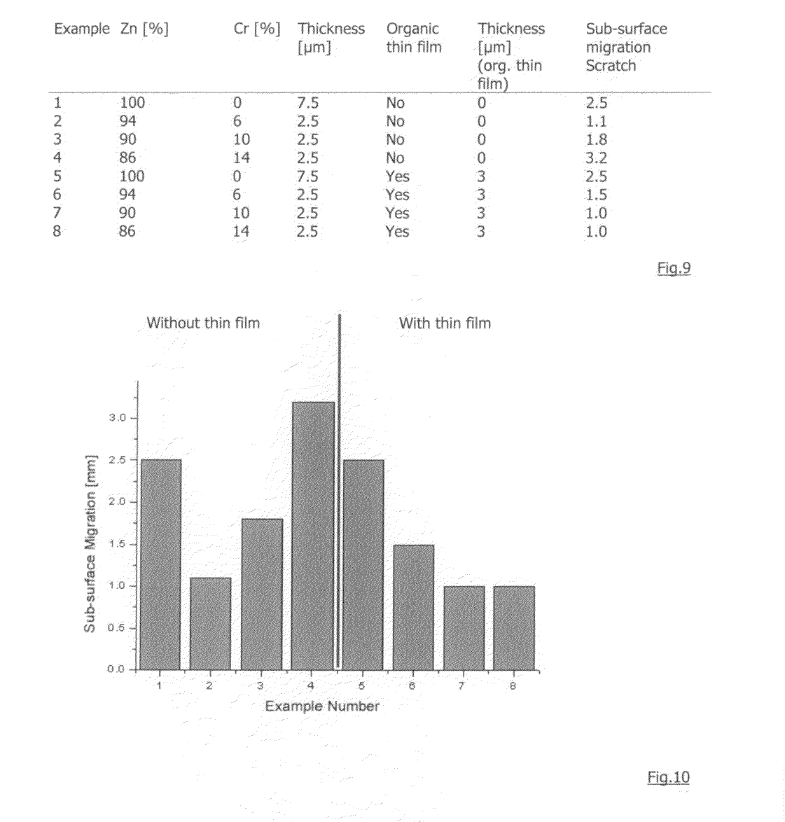

VI.3 Sub-surface Migration in Scratches (See FIGS. 9 and 10)

Samples 1 and 5 of the total of eight samples again are pure electrolytically applied zinc layers with a thickness of 7.5 μm. One has an organic coating (sample 5), and one does not have one (sample 1). Here, the organic coating does not show any influence on the scratch sub-surface migration, which is a known fact for the corrosion-protective primers conventionally used in electrolytically applied zinc layers.

A significant increase in sub-surface migration can be observed to occur with an increase in chromium content in the three samples which have zinc-chromium coatings with increasing chromium content and a layer thickness of 2.5 μm. In total, sub-surface migration is less in two samples than in the pure zinc layer that is, in total, three times thicker, which demonstrates the remarkable corrosion-protective effect of the relatively thin zinc-chromium layer. However, the third sample with a chromium content of 14% exhibits a poorer performance also with regard to scratch sub-surface migration than the pure zinc layer.

Surprisingly, the organic coating in combination with the zinc-chromium layer shows a surprisingly diametrically opposed behaviour with regard to the scratch sub-surface migration. With a growing chromium content and with the organic coating having a thickness of 3 μm, even the behavior with regard to the scratch sub-surface migration at a growing chromium content improves, or remains the same at high chromium content. This is completely contrary to the expectations of the person skilled in the art, so that, obviously, a synergistic effect between the relatively thin zinc-chromium layer and the organic coating can be observed here, in particular at high chromium contents.

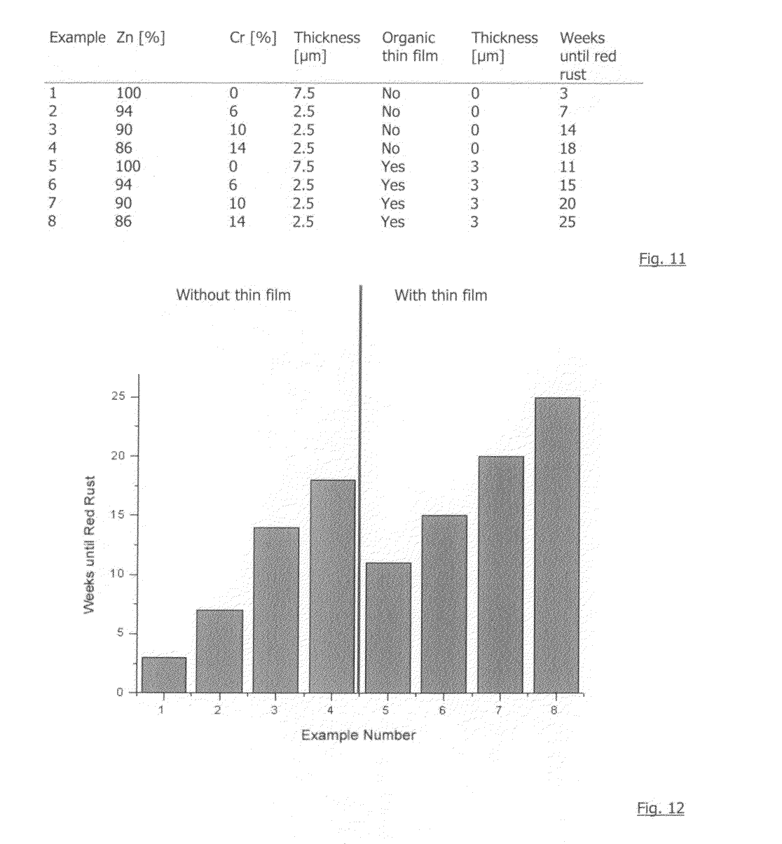

VI.4 Corrosion (Up to Red Rust) on the Flange (See FIGS. 11 and 12)

Again, eight samples were also used for the flange corrosion test, with samples 1 and 5 being pure electrolytic galvanizations on steel sheets with a thickness of 7.5 μm, one with an organic coating and one without. In the case of the flange corrosion, the known fact became clear that flange corrosion can effectively be reduced with a corrosion-protective primer. In the prior art, that is the reason for using the corrosion-protective primer in pure zinc layers.

However, the test also makes clear why corrosion-protective primer layers or organic coatings were not used or considered for zinc-chromium coatings up to now. The zinc-chromium layer is so superior to the pure zinc layer with corrosion-protective primer, already at a conventional zinc-chromium ratio of 90:10, that the corrosion-protective primer would not have to be used in a zinc-chromium layer in order to improve the flange corrosion.

However, samples 6, 7 and 8 show that the corrosion-protective primer improves the corrosion-protective effect also in zinc-chromium layers. In this case, zinc-chromium layers with a corrosion-protective primer layer are obviously far superior to conventional zinc layers (FIGS. 11 and 12), even at considerably lower thicknesses.

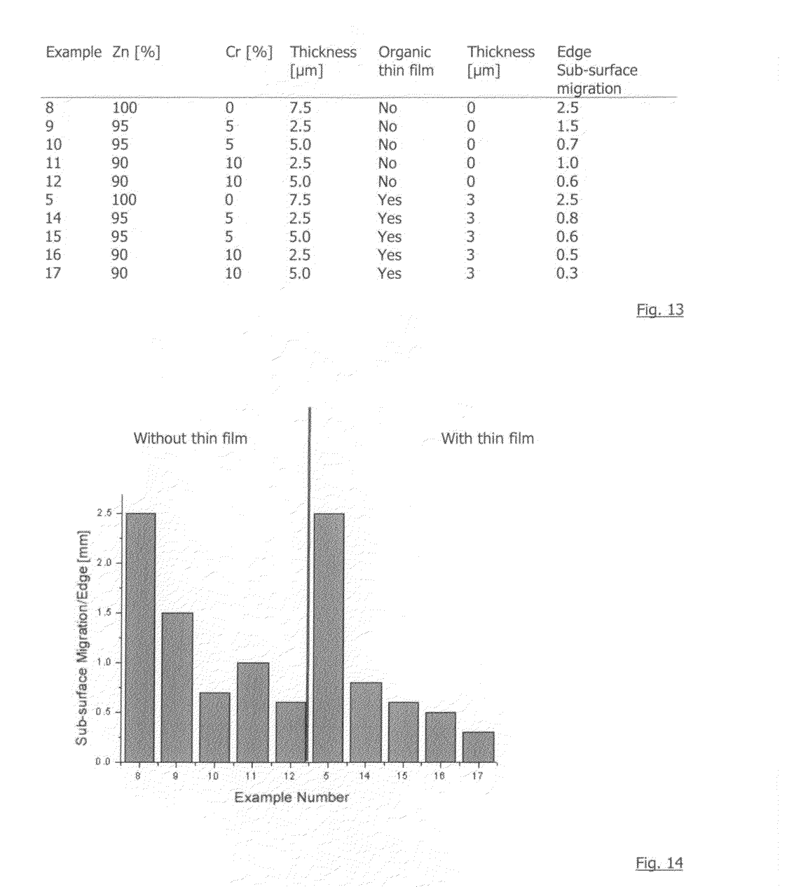

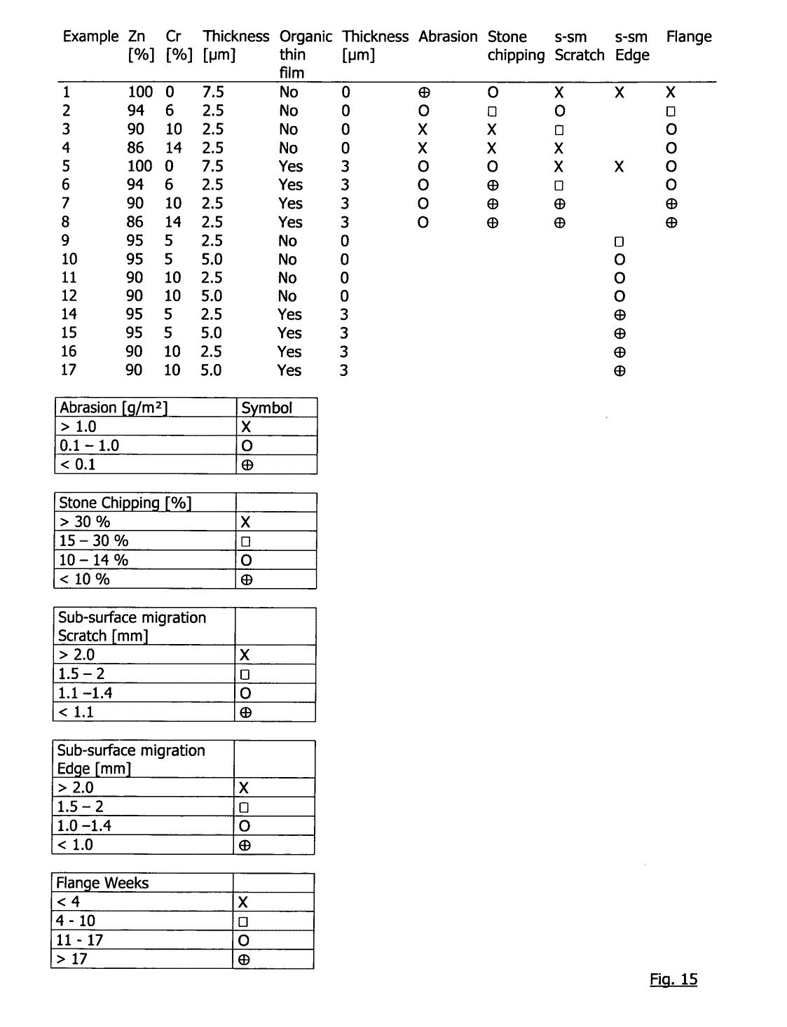

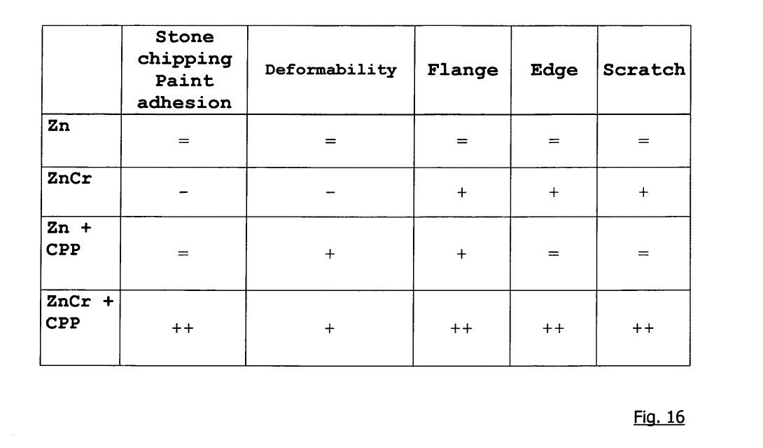

VI.5 Edge Sub-Surface Migration (See FIGS. 13, 14)

Two samples having an electrolytic zinc layer and a coating thickness of 7.5 μm were compared in order to examine the corrosion sub-surface migration on the edge, with one sample (5) having an organic coating of 3 μm and one sample without organic coating (8) being examined. These samples were compared with four samples having zinc-chromium layers, with the zinc-chromium ratio being 95:5 in one case and 90:10 in another, with a layer thickness of 2.5 μm and 5 μm, respectively, in each of these cases. These samples were used with an organic coating (samples 14 to 17) and without organic coating (samples 9 to 12), respectively.

First of all, it can be said that the corrosion-protective primer has no influence at all on sub-surface migration behavior in pure zinc layers. Sub-surface migration with an organic coating matched exactly that without organic coating. In contrast, a zinc-chromium layer having a chromium content of 5% and a layer thickness of 2.5 μm, that is one-third of the zinc layer, already was clearly superior to the zinc layer with regard to the sub-surface migration behavior. With a layer thickness of 5 μm, sub-surface migration behavior could be improved by a factor of two in a practically linear manner.

With a chromium content of 10%, the sub-surface migration behavior at a layer thickness of 2.5 μm was further improved over the slightly thinner layer; at a layer thickness of 5 μm, the zinc-chromium layer having a chromium content of 5% is practically equal to the zinc-chromium layer with 10% chromium.

Contrary to these behaviors of zinc-chromium layers, which are dependent on the thickness on the one hand and on the chromium content on the other hand, effects are obtained at these same ratios by applying an organic coating (such as, for example, cpp), which could not be expected to occur in this way.

In a layer having a chromium content of 5%, the sub-surface migration behavior at the edge is improved significantly by the organic coating, so that the advance of the sub-surface migration can be cut almost by half. Given a greater layer thickness, but with a chromium content of 5%, an improvement cannot be achieved by using the corrosion-protective primer or the organic coating. Curiously, a further improvement can be achieved, however, with the higher chromium content of 10% and the organic coating, so that edge sub-surface migration can be cut in half again by the organic coating or the corrosion-protective primer as compared with a non-coated zinc-chromium layer having a chromium content of 10%.

Therefore, it may be assumed that there is a synergistic effect, in particular between the chromium content of a zinc-chromium layer and the use of organic coatings or corrosion-protective primers that has not been observed until now. So far, it could not be definitively determined what this synergistic effect is based on.

During the coating of conventional zinc layers with a corrosion-protective primer, a pre-treatment is carried out with special chemicals, and the corrosion-protective primer is subsequently applied. The corrosion protection and the paint adhesion are deficient without this chemical pre-treatment. Surprisingly, such a chemical pre-treatment can be omitted in the case of zinc-chromium layers.

VII Summary

In summary, it can be said, based on the tests, that there is obviously an interaction between a zinc-chromium coating on the one hand and a synthetic-resin based organic coating applied thereon on the other hand, particularly a corrosion-protective primer coating, which clearly goes beyond a cumulative effect of the two systems.

This becomes particularly clear with regard to the edge sub-surface migration, where the interactive effect between the corrosion-protective primer and the zinc-chromium coating becomes particularly clear at high chromium contents.

However, this also becomes clear in the abrasion tests, in which abrasion increases in the known system of the electrolytic zinc layer+corrosion-protective primer, in which abrasion increases with the chromium content in known zinc-chromium coatings (which was also known), but in which abrasion decreases, given a zinc-chromium coating and a corrosion-protective primer. Such a behavior was not known from the prior art and the investigations until now, and it was also not to be expected.

The invention is advantageous in that a corrosion-protective system in the shape of a corrosion-protective layer is provided which is far superior in every important parameter to a pure electrolytic zinc layer, an electrolytic or hot-dip galvanized zinc layer plus corrosion-protective layer and a zinc-chromium layer, and which, above all, results in excellent paint adhesion.

Additionally, this layer has a total thickness which is significantly less, in particular half the size, as that of a known electrolytic zinc-layer, and only one-fourth the thickness of a hot-dip galvanized layer, each with a corrosion-protective primer.

The corrosion-protective layer according to the invention can be applied much faster due to the lower layer thickness, and, due to its considerably higher mechanical and chemical resistance, allows for greater drawing depths and drawing speeds, and therefore also the manufacture of complex components without loss of corrosion protection.

According to the invention, two corrosion protection systems cooperate which had hitherto not been combined due to the prejudice of the experts, where the known disadvantages of a pure zinc-chromium layer led to them not having been used on a large scale in the first place. Effects which are not limited to a mere improvement of the corrosion protection, which as such possibly was to be expected, result from the combination of the two corrosion protection systems, the zinc-chromium layer on the one hand and the corrosion-protective primer or organic coating on the other hand. Rather, the mechanical properties are also improved to such an extent that it could not at all have been expected based on previous tests of other corrosion-protective layers with organic coatings.

1. A corrosion-protective layer for protecting steel substrates from corrosion, comprising a zinc-chromium layer located on a steel substrate applied by electrolytic joint deposition of zinc and chromium ions, and a chromate-free organic thin layer applied thereon, the chromate-free organic thin layer substantially comprising synthetic resins.

2. The corrosion-protective layer according to claim 1, wherein the zinc-chromium layer comprises 1 to 25% chromium, the remainder being, for the most part, zinc and possibly accompanying elements as well as common impurities.

3. The corrosion-protective layer according to claim 2, wherein the chromium content is 3 to 10%, the remainder being zinc and possibly accompanying elements as well as common impurities.

4. The corrosion-protective layer according to claim 1, wherein the zinc-chromium layer has a thickness of 1 to 10 μm.

5. The corrosion-protective layer according to claim 1, wherein the thickness of the zinc-chromium layer is 2 to 6 μm.

6. The corrosion-protective layer according to claim 1, wherein the thickness of the zinc-chromium layer is 2.5 to 5 μm.

7. The corrosion-protective layer according to claim 1, wherein the thickness of the zinc-chromium layer depends on the chromium content of the layer, the layer having a thickness of 5 to 10 μm where the chromium content is low, and a thickness of 1 to 5 μm where the chromium content is high.

8. The corrosion-protective layer according to claim 1, wherein the organic layer comprises electrically conductive particles, wherein the layer is formed to be paint-like on a synthetic-resin basis.

9. The corrosion-protective layer according to claim 1, wherein the organic layer comprises metal particles as electrically conductive particles.

10. The corrosion-protective layer according to claim 1, wherein the synthetic resin-based organic layer comprises at least one of the group consisting of polyurethane, epoxy resin, phenolic resin, and melamine resin.

11. The corrosion-protective layer according to claim 1, wherein the organic layer further comprises at least one of the group consisting of polyester, guanidine derivatives, ureas, cyclic amines, aromatic amines, and alcohols.

12. The corrosion-protective layer according to claim 1, wherein the organic layer is a thin-film coating.

13. The corrosion-protective layer according to claim 1, wherein the organic layer is formed from a conventional corrosion-protective primer.

14. The corrosion-protective layer according to claim 1, wherein the thickness of the organic thin film on the zinc-chromium layer is 0.5 to 10 μm.

15. The corrosion-protective layer according to claim 14, wherein the thickness of the organic thin film is 1.5 to 6 μm.

16. The corrosion-protective layer according to claim 15, wherein the thickness of the organic thin film is 3 μm.

17. A method for producing a corrosion-protective layer having an improved paint-adhesion based on a zinc-chromium corrosion-protective layer on steel substrates, the method comprising applying an organic chromate-free thin film comprising synthetic resins onto an electrolytically-deposited zinc-chromium layer.

18. The method according to claim 17, wherein the deposition of the zinc-chromium layer is carried out from an acid sulfate electrolyte with divalent zinc and trivalent chromium.

19. The method according to claim 17, further comprising using polyethylene glycol as an additive for the codeposition of chromium into the layer.

20. The method according to claim 17, further comprising applying the organic thin film onto the electrolytically-deposited zinc-chromium layer without pre-treatment.

21. The method according to claim 17, comprising carrying out chemical conversion treatment for improving adhesion prior to applying the organic thin film, and further comprising applying a solution that includes an organic polymer and at least one of the group consisting of phosphates, fluorotitanates, and fluorozirconates, using a no-rinse process, thus forming an amorphous layer.

22. The method according to claim 17, comprising applying the thin-film coating using a coil coating method.

23. The method according to claim 17, comprising applying the thin-film coating in a thickness of 0.5 to 10 μm.

24. The method according to claim 17, wherein the organic layer includes electrically-conductive particles, and the synthetic resins include at least one of the group consisting of polyurethane, epoxy resin, phenolic resin, and melamine resin.

25. The method according to claim 17, comprising using a commercially-available corrosion-protective primer as the organic thin-film coating for coating electrolytically galvanized or hot-dip galvanized steel substrates.

26-27. (canceled)
